(19) United States
(12) Patent Application Publication
(10) Pub. No.: US 2010/0259391 A1
(43) Pub. Date: Oct. 14, 2010

(54) Electronic Article Surveillance Marker

(76) Inventors: Dennis M. Gadonniex, Bradenton, FL (US); Norman Hansen, Highland Beach, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/464,532

(22) Filed: May 12, 2009

Related U.S. Application Data
(63) Continuation of application No. 11/500,169, filed on Aug. 7, 2006, now abandoned.

(51) Int. Cl. G08B 13/14; H04Q 5/22

(52) U.S. Cl. 340/572.6; 340/10.4

(57) ABSTRACT

A magnetomechanical marker for use in an electronic article surveillance system comprising a magnetomechanical element, a bias magnet and a housing. The magnetomechanical element comprises first and second resonator strips composed of an unannealed magnetostrictive amorphous metal alloy having a resonant frequency response including a resonant frequency minimum in response to the incidence thereon of an electromagnetic interrogating field. The bias magnet has a bias point to magnetically bias the magnetomechanical element so that the magnetomechanical element resonates at a predetermined frequency in the presence of an electromagnetic interrogating field. The housing has a cavity sized and shaped to accommodate the first and second resonator strips positioned in the cavity in registration and to allow the first and second resonator strips to mechanically vibrate, wherein the first resonator strip has a first weight and first shape and is positioned proximate the second resonator strip so that the first weight and the first shape mechanically interfere with the second resonator strip to impart a stress on the second resonator strip which shifts the resonant frequency minimum to the bias point.

### CROSS-REFERENCE TO RELATED APPLICATION

N/A

### STATEMENT REGARDING FEDERALLY SPONSORED RESEARCH OR DEVELOPMENT

N/A

### BACKGROUND OF THE INVENTION

This invention relates to electronic article surveillance systems and, more particularly, to a magnetomechanically resonant marker for use in article surveillance systems.

Attempts to protect articles of merchandise and the like against theft from retail stores have resulted in numerous technical arrangements, often termed electronic article surveillance. Many of the forms of protection employ a tag or marker secured to articles for which protection is sought. The marker responds to an electromagnetic interrogation signal from a transmitting antenna situated proximate either an exit door of the premises to be protected, or an aisle adjacent to the cashier or checkout station. A nearby receiving antenna receives a signal produced by the marker in response to the interrogation signal. The presence of the response signal indicates that the marker has not been removed or deactivated by the cashier, and that the article bearing it may not have been paid for or properly checked out.

U.S. Pat. No. 4,510,489, issued to Anderson et al., discloses a magnetomechanical electronic article surveillance system in which markers incorporating a magnetostrictive active element are secured to articles to be protected from theft. The active elements are formed of a soft magnetic material, and the markers also include a control element, which is biased or magnetized to a predetermined degree so as to provide a bias field which causes the active element to be mechanically resonant at a predetermined frequency. The markers are detected by means of an interrogation signal generating device which generates an alternating magnetic field at the predetermined resonant frequency, and the signal resulting from the mechanical resonance is detected by receiving equipment.

According to one embodiment disclosed in the Anderson et al. patent, the interrogation signal is turned on and off, or “pulsed,” and a “ring-down” signal generated by the active element after conclusion of each interrogation signal pulse is detected. Typically, magnetomechanical markers are deactivated by degaussing the control element, so that the bias field is removed from the active element thereby causing a substantial shift in the resonant frequency of the active element.

The disclosure of the Anderson et al. patent is incorporated herein by reference.

Variations in bias field strength, as well as the influence of external magnetic fields, can cause the resonant frequency of the marker to vary from its target value. This change in the resonant frequency can cause the markers to be outside the predetermined frequency detection range of the electronic article surveillance system resulting in markers that may not be detected by the surveillance system. In addition, there is an advantage to biasing a nonlinear resonator at the frequency minimum because when this label is deactivated, namely, degaussed, the resonator will shift higher in frequency which reduces the false alarm occurrences in an electronic article surveillance system. The frequency minimum is defined as the minimum frequency value and bias level at which this frequency minimum occurs on the frequency verses bias field relationship. The frequency minimum occurs where the frequency verses bias slope equals zero.

The linear resonator configuration taught by U.S. Pat. No. 5,469,140 offers acceptable signal amplitude response in the interrogation zone of an electronic article surveillance system; however, it is difficult to manufacture this marker to match the industry standard interrogation frequency of 58 kHz. The manufacturing difficulties are due to the fact that the frequency minimum occurs at a very high bias field level. Typical bias magnets will impart an apparent DC field on the order of 6.5 oersteds to the resonator which forces the manufacturer to bias the resonator on the steep slope of the frequency-bias field curve. This high slope adds frequency instability to stray magnetic fields. In addition, the frequency well is typically over 10 oersteds in a linear material. It is neither practical nor economical to produce a flat label product with a strong magnet which imparts a 10 oersteds field due to the high magnetic force of attraction which causes amplitude energy losses due to friction. As cast nonlinear resonator material also has a frequency minimum which occurs at a high bias field in the range of 7.5 to 9 oersteds. Magnets with this amount of bias field strength also cause excess amplitude losses due to friction.

U.S. Pat. No. 6,359,563 to Herzer discloses a method of making a magnetoacoustic electronic article surveillance marker wherein two or more short strips of amorphous ribbon are disposed in registration in a housing to form a dual or multiple resonator that produces a resonant signal amplitude that is comparable to the resonant signal amplitude that is produced by a conventional magnetoacoustic marker employing a single piece of resonator material that is about twice as wide as the resonator strips utilized by Herzer. Placing the pieces in registration means that the pieces are disposed one over the other with a substantial overlap, if not exact congruency. The magnetostrictive amorphous ribbon used in Herzer is an Fe—Ni—Co-base alloy with an iron content of more than about 15 atomic percent and less than about 30 atomic percent which is annealed in the presence of a magnetic field perpendicular to the ribbon axis and/or with a tensile stress applied along the ribbon axis. Herzer also teaches that prior art resonator strips that have been optimized for multiple resonator labels have proven to be unsuitable for single resonator labels and vice versa. Herzer discloses that by appropriate choice of resonator alloy composition and heat treatment that it is possible to provide an annealed alloy ribbon that is suitable for single and dual resonator applications.

Electronic article surveillance systems in today's market use deactivation devices comprising magnetic or electromagnetic pads to deactivate magnetomechanical markers by demagnetizing the bias magnet of the marker. To be commercially viable, a magnetomechanical marker must have a bias magnet coercivity in a range that can be demagnetized at a distance from the deactivator devices to which the industry has become accustomed. However, the bias magnet must not be overly sensitive to stray magnetic fields that may affect the frequency response of the marker, thereby rendering it undetectable by the surveillance system. Although there have been improvements in electronic article surveillance markers since the first markers according to Anderson et al.; nevertheless, none of the solutions have totally satisfied the marketplace. Accordingly, there has been a long felt need in the industry for an improved magnetomechanical marker for electronic article surveillance systems.

### SUMMARY OF THE INVENTION

In accordance with the present invention, there is provided a magnetomechanical marker for use in an electronic article surveillance system comprising a magnetomechanical element, a bias magnet and a housing. The magnetomechanical element comprises first and second resonator strips composed of an unannealed magnetostrictive amorphous metal alloy having a resonant frequency response including a resonant frequency minimum in response to the incidence thereon of an electromagnetic interrogating field. The bias magnet has a bias point to magnetically bias the magnetomechanical element so that the magnetomechanical element resonates at a predetermined frequency in the presence of an electromagnetic interrogating field. The housing has a cavity sized and shaped to accommodate the first and second resonator strips positioned in the cavity in registration and to allow the first and second resonator strips to mechanically vibrate, wherein the first resonator strip has a first weight and first shape and is positioned proximate the second resonator strip so that the first weight and the first shape mechanically interfere with the second resonator strip to impart a stress on the second resonator strip which shifts the resonant frequency minimum to the bias point.

In one embodiment of the present invention, the unannealed magnetostrictive amorphous metal alloy comprises on an elemental weight basis about 2.8 to about 5% boron, about 0 to about 9.5% molybdenum, about 41 to about 55% nickel, and about 33 to about 48 percent iron. In a second embodiment of the present invention, the bias magnet comprises on an elemental weight basis about 1 to about 12 percent chromium and about 88 to about 99 percent iron. In another embodiment, the bias magnet has a frequency versus bias slope from about 0 to about 250 hertz per oersted to magnetically bias the magnetomechanical element, the bias material imparting a field between about 450 and about 550 ampere-turns per meter equivalent to 5.65 to 6.9 oersteds on the first and second resonator strips. In still another embodiment of the present invention, the bias magnet comprises on an elemental weight basis about 8 to about 18 percent manganese and about 82 to about 92 percent iron.

The present invention provides a shallow cavity magnetomechanical electronic article surveillance marker that can be produced using as cast, i.e., unannealed, resonator material biased at the minimum point of the bias-frequency curve. The magnetomechanical marker has enhanced deactivation and magnetic stability since the marker is biased at the frequency minimum. The resonator material can be slit after casting. Applicant has found that combining the described unannealed, nonlinear resonator material and described abrupt low energy bias in the dual resonator configuration of the present invention, the weight and shape of the first resonator mechanically interfere with the second resonator to impart a stress on the second resonator, which shifts the frequency minimum of the marker to the bias point, thereby providing maximum frequency shift when the marker is deactivated and improved frequency stability. The present invention also provides maximum marker signal at the bias point.

In accordance with the present invention, there is also provided an electronic article surveillance system comprising: an antenna for generating an electromagnetic field alternating at a selected frequency in an interrogation zone; a magnetomechanical marker comprising: a magnetomechanical element comprising first and second resonator strips composed of an unannealed magnetostrictive amorphous metal alloy having a resonant frequency response including a resonant frequency minimum in response to the electromagnetic field, a bias magnet having a bias point to magnetically bias the magnetomechanical element so that the magnetomechanical element resonates at a predetermined frequency in the presence of the electromagnetic field, and a housing having a cavity sized and shaped to accommodate the first and second resonator strips positioned in the cavity in registration and to allow the first and second resonator strips to mechanically vibrate, wherein the first resonator strip has a first weight and first shape and is positioned proximate the second resonator strip so that the first weight and first shape mechanically interfere with the second resonator strip to impart a stress on the second resonator strip which shifts the resonant frequency minimum to the bias point; and an antenna for detecting the mechanical vibration of the magnetomechanical element.

Other advantages and applications of the present invention will be made apparent by the following detailed description of the preferred embodiment of the invention.

### BRIEF DESCRIPTION OF THE DRAWINGS

FIG. 1 is an exploded, perspective view of an electronic article surveillance marker in accordance with the present invention.

FIG. 2 is an exploded, end-on, cross-sectional view of the electronic article surveillance marker of FIG. 1.

FIG. 3 is a plan view of one embodiment of an electronic article surveillance marker cavity of the invention.

FIG. 4 is a graph of the DC magnetic field deactivation of an electronic article surveillance marker of the present invention.

FIG. 5 is an illustration of the behavior of one embodiment of the present invention.

FIG. 6 is a graph of enhanced performance characteristics of an electronic article surveillance marker according to present invention.

FIG. 7 is block diagram of an electronic article surveillance system utilizing electronic article surveillance markers of the present invention.

### DETAILED DESCRIPTION OF THE INVENTION

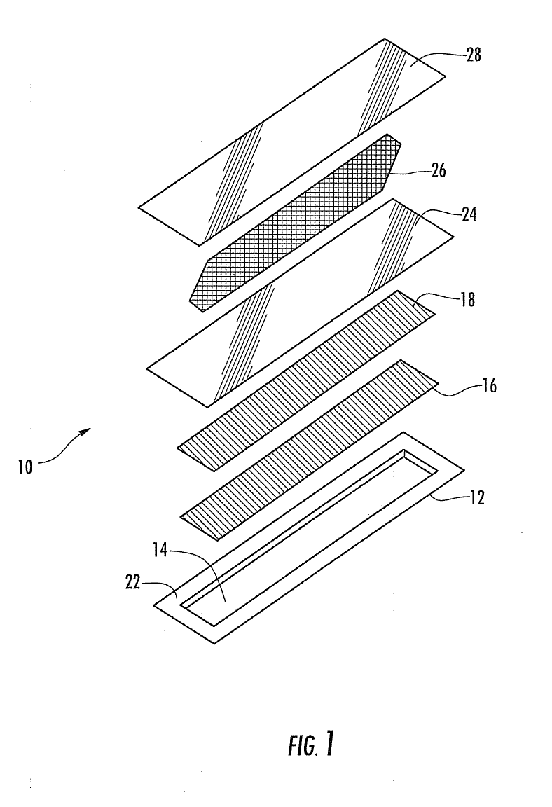

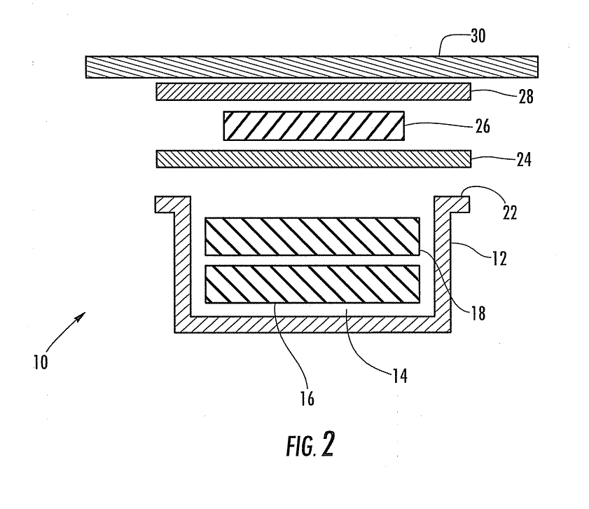

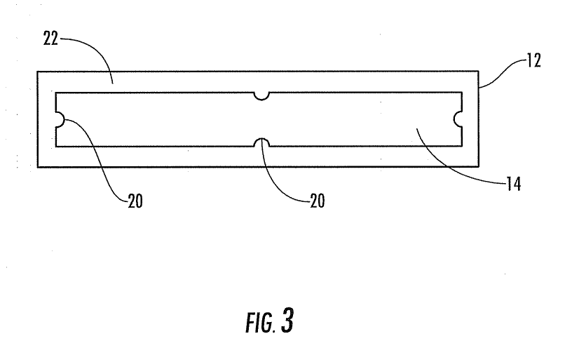

Referring to FIGS. 1-3, a marker 10 for use in an electronic article surveillance system has a housing 12 composed of sheet-form plastic material in which an indentation or cavity 14 is formed. Housing 12 has the shape of a rectangular prism and is open on one of its large faces. Cavity 14 is sized to accommodate a magnetomechanical element, such as two resonator strips 16 and 18 placed therein in stacked registration. Resonator strips 16 and 18 can have a width, for example of 6 mm. Optionally, small projections 20 are molded into the long sides and/or ends of cavity 14. Projections 20 facilitate centering resonator strips 16 and 18 in cavity 14 without unduly constraining them mechanically. Housing 12 has lips 22 surrounding cavity 14 on all four sides. The depth of cavity 14 is defined generally by the spacing between the plane of the bottom of the cavity 14 and the parallel plane of the surfaces of lips 22. A layer of fiat polymer sheet or lidstock 24 is placed over cavity 14 and sealed to lips 22 to encase resonator strips 16 and 18 within cavity 14, while permitting resonator strips 16 and 18 to mechanically vibrate freely. Preferably, lidstock 24 is heat sealed to lips 22, although the use of glue or other like adhesive agent, ultrasonic welding, or other attachment means can also be used. One suitable material for lidstock 24 is polyethylene-polyester laminate.

A bias magnet 26 for providing a DC bias field is associated with housing 12 by being placed on lidstock 24, which separates bias magnet 26 from resonator strips 16 and 18. Preferably, bias magnet 26 is in the form of an acute-angle parallelogram or rectangle. A cover 28, which is coated on both sides with a pressure-sensitive adhesive, is applied to secure bias magnet 26 to lidstock 24 and permit attachment of marker 10 to, for example, a merchandise item. For convenience of automated manufacture, handling, distribution, and subsequent end use, marker 10 is removably attached by the adhesive on the exterior surface of cover 28 to a release liner 30. Exemplary material for release liner 30 is paper or thin polyester.

The magnetomechanical element preferably consists essentially of two rectangular strips of an amorphous metal alloy sold commercially as ribbon by Metglas, Inc., Conway, S.C., under the trade name METGLAS® 2826MB. The magnetostrictive amorphous metal alloy comprises on an elemental weight basis about 2.8 to about 5 weight % boron, about 0 to about 9.5 weight % molybdenum, about 41 to about 55 weight % nickel, and about 33 to about 48 weight percent iron, and, for example, can have a nominal composition (atom percent) Fe₄₀Ni₃₈Mo₄B₁₈. The 2826MB alloy is a magnetostrictive, soft ferromagnetic material, having a saturation magnetostriction constant (λₛ) of about 12×10⁻⁵, a saturation magnetization (Bₛ) of about 0.8 T, and a coercivity (H_{c}) of about 8 A/m (0.1 Oe). The resonator strips are used in the as-received condition from the manufacturer and are not subjected to any further heat-treatment. The resonating strips in a preferred implementation are about 1.5 inches long, resulting in acoustomagnetic resonance for an electromagnetic exciting frequency of about 56-60 kHz.

In one embodiment, bias magnet 26 is composed of Arnokrome 4, which is the trade name for a bias material having a composition of between about 1 and about 12 weight percent chromium with the balance being iron, sold by Arnold Magnetics, Marengo, Ill. When measured in a Hysteresis Loop Tracer with peak excitation field level of 250 Oe, and operating drive field frequency of 60 Hz, a sample 6.0 mm wide, 76.2 mm long, and 25.4 μm thick exhibits the following semi-hard magnetic properties: (i) a Remanence Bᵣ: 1.4±0.1 tesla; (ii) Coercivity H_{c}: 19±5 oersteds; and (iii) Remanent Flux Fᵣ: 390±60 nano-webers, wherein Fᵣ=Bᵣ*A and A is the cross sectional area of the ribbon sample. The Arnokrome 4 material additionally has the following properties when magnetized in a uniform solenoidal DC field of applied to a sample 6.0 mm wide×28.6 mm long: (i) the sample is magnetized to within 2% of its saturated remanent flux in a field of 100 Oe; (ii) the sample retains >12% of its saturated remanent flux after exposure to a demagnetizing DC field of strength 8 Oe; (iii) after exposure to a 25 Oe demagnetizing AC field, the saturated sample retains no more than 30% of its saturated remanent flux, the demagnetizing field having an exponentially decreasing waveform; and (iv) a saturated sample, when bent around a radius of 13.5 mm does not exhibit a loss of magnetism of greater than 12% of the saturated remanent flux.

In another embodiment bias magnet 26 is composed of Arnokrome 5, which is the trade name for a bias material having a composition of between about 8 and 18 weight percent manganese with the balance being iron, sold by Arnold Magnetics, Marengo, Ill.

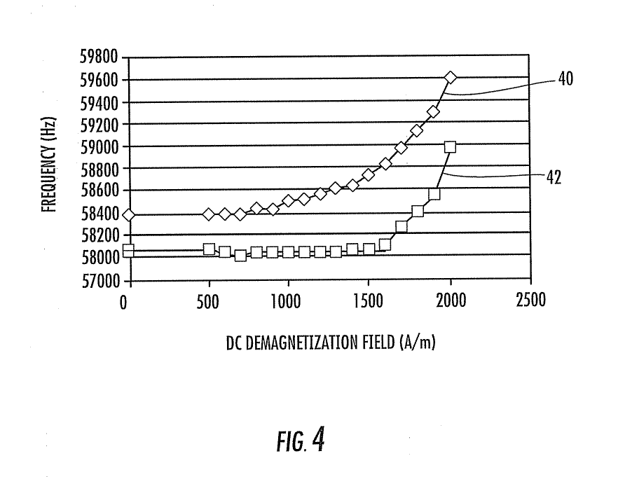

FIG. 4 illustrates the marker deactivation curve for a marker of the present invention having a bias material of Arnokrome 4, which is illustrated by curve 40, and Arnokrome 5, which is illustrated by curve 42. Both markers had dual resonator strips in registration with the 2826 MB resonator material. The frequency of the marker is provided on the vertical axis in hertz, and the DC magnetic field is provided on the horizontal axis in ampere-turns per meter. This curve was generated by applying a DC field to a marker of the present invention in the degaussing direction. This field was supplied by the DC coils of the label tester. After applying the degaussing DC, field, the frequency was recorded. The DC field was applied in increments of 100 A/m in order to generate the DC demagnetization curve for the given markers. As the marker is degaussed, the frequency of the marker will increase in proportion to the reduction in the remanent magnetic field of the bias material. In effect, the label acts like a gauss meter. The demagnetization curves describe a more gradual decay in remanent magnetization frequency starts to increase at 900 A/m for the marker with the Arnokrome 4 bias material. This is expected because the Arnokrome 4 bias material has more of a sheared hysteresis loop which makes the bias less abrupt than the Arnokrome 5 bias material. The Arnokrome 5 bias material starts to decay later than the Arnokrome 4 bias material at 1500 A/m but decays much more quickly at 2000 A/m, thereby illustrating the more abrupt nature of the hysteresis loop of the Arnokrome 5 bias material.

The Arnokrome 4 bias material, when used as bias magnet 26, imparts a field which is based upon the position of the magnet relative to the resonator strips between 450 and 550 A/m (5.65 to 7.0 Oe) upon dual resonator strips 16 and 18, which is near the frequency minimum of the curve. At the frequency minimum the entire frequency shift is utilized upon degaussing bias magnet 26 during deactivation, which enhances the deactivation behavior of marker 10. At the frequency minimum, the slope of the frequency vs. magnetic field curve is minimized. When marker 10 is in the active condition, this low slope imparts frequency stability in the presence of stray magnetic fields such as the earth's magnetic field. The active response of marker 10 should be enhanced in all orientations within an AC interrogation field. The Arnokrome 4 bias material also provides a low coercivity bias magnet with a high degree of squareness in its flux density (B) versus DC magnetization field (H) curve, which will provide a rapid shift of marker 10 from the active state to the deactivated state.

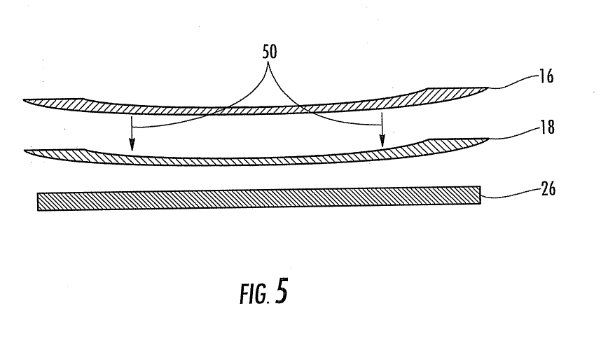

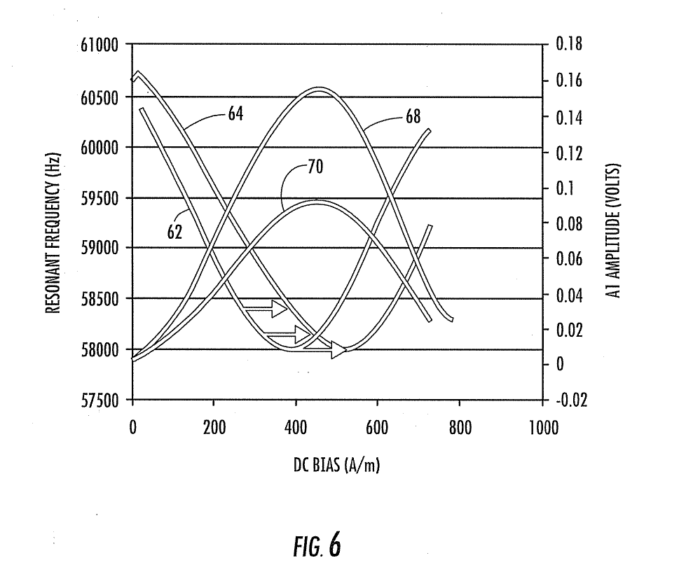

It has been found that utilizing the nonlinear, amorphous METGLAS® 2826MB resonator material in the dual resonator configuration illustrated in FIG. 5 imparts a stress, which is indicated by arrows 50, upon resonator strip 18 due to the forces of gravity and magnetic attraction. It has been further found that this stress field influences the frequency response of the dual resonator label such that the frequency well is shifted to a higher field level as illustrated by the graph in FIG. 6. The resonant frequency in hertz of a marker for use in an electronic article surveillance system is provided on the left-hand vertical axis. The amplitude in volts of the signal from a marker for use in an electronic article surveillance system in response to an interrogating magnetic field is provided on the right-hand vertical axis. The DC bias in amperes per meter is provided on the horizontal axis. The curves were generated from a composite of actual marker measurements taken on a coil tester. Curve 62 illustrates the frequency verses dc bias curve of a single nonlinear amorphous resonator composed of the METGLAS® 2826MB resonator material and a bias magnet composed of the Arnokrome 4 bias material. Curve 64 illustrates the frequency verses DC bias curve of a dual nonlinear amorphous resonator composed of the METGLAS® 2826MB resonator material and a bias magnet composed of the Arnokrome 4 bias material according to the present invention. Arrows 66 indicate the shift in the frequency curve sustained when two resonator strips are stacked in a dc bias field. Curve 68 is the voltage amplitude signal generated by the dual resonator embodiment of the present invention. Curve 70 is the signal generated by a single resonator embodiment. As discussed above, the Arnokrome 4 bias material, when used as bias magnet 26, imparts a field between 450 and 550 A/m upon dual resonator strips 16 and 18, which is near the frequency minimum of the curve. It should also be noted that the signal maximum for this configuration also occurs between the 450 to 550 A/m bias range, thereby providing maximum signal output at the bias point. This shift in resonant frequency minimum allows for increased deactivation and centers the frequency minimum on the imposed bias field of the magnet. The frequency curve shift caused by the dual resonator configuration is different than the frequency shift caused by deactivation. The frequency change created by the dual resonator interaction is a frequency curve shift not a frequency shift. In deactivation, the bias is degaussed which shifts or lowers the bias field level imposed by the magnet and increases the frequency response of the label while lowering the amplitude response. For the dual resonator nonlinear label with 2826MB and Arnokrome 4 or Arnokrome 5 bias material, the range for biasing the marker at or near its frequency minimum and is defined by the slope of the resonant frequency versus the applied DC bias curve which should be less than about 250 Hz/Oe.

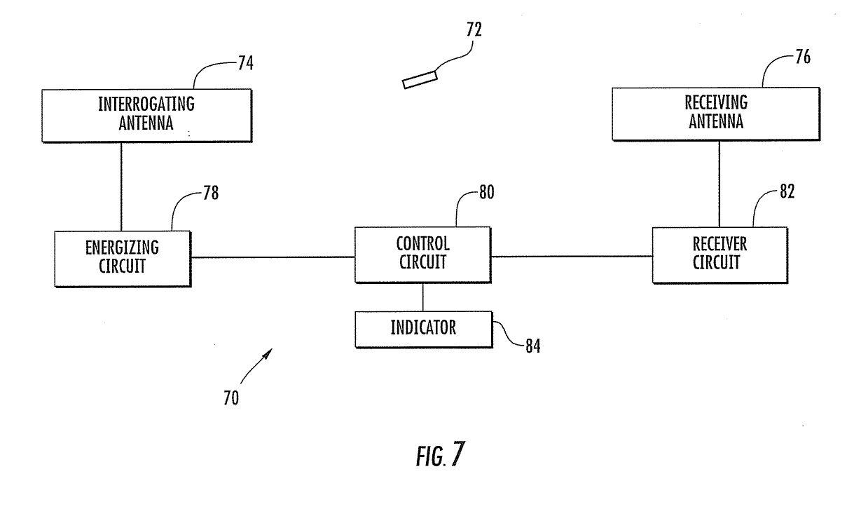

FIG. 7 is a block diagram illustrating an electronic article surveillance system 70 using marker 70, which is an electronic article surveillance marker made in accordance with the present invention. System 70 includes interrogating antenna 74, receiving antenna 7, energizing circuit 78, control circuit 80, receiver circuit 82, and indicator 84. In operation, energizing circuit 78, under control of control circuit 80, generates an interrogation signal and drives interrogating antenna 74 to radiate the interrogation signal within an interrogation zone disposed between interrogating antenna 74 and receiving antenna 76. Receiver circuit 82 via receiving antenna 76 receives signals present in the interrogation zone. Receiver circuit 82 conditions the received signals and provides the conditioned signals to control circuit 80. Control circuit 80 determines, from the conditioned signals, whether an active marker 72 is present in the interrogation zone. If an active marker 72 is in the interrogation zone, marker 72 will respond to the interrogation signal by generating a marker signal. The marker signal will be received via receiving antenna 76 and receiver circuit 82, and be detected by control circuit 80, which will activate indicator 84 to generate an alarm indication that can be audible and/or visual.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

1. A magnetomechanical marker for use in an electronic article surveillance system comprising: a magnetomechanical element comprising first and second resonator strips composed of an unannealed magnetostrictive amorphous metal alloy having a resonant frequency response including a resonant frequency minimum in response to the incidence thereon of an electromagnetic interrogating field; a bias magnet having a bias point to magnetically bias said magnetomechanical element so that said magnetomechanical element resonates at a predetermined frequency in the presence of an electromagnetic interrogating field; and a housing having a cavity sized and shaped to accommodate said first and second resonator strips positioned in said cavity in registration and to allow said first and second resonator strips to mechanically vibrate, wherein said first resonator strip has a first weight and first shape and is positioned proximate said second resonator strip so that said first weight and said first shape mechanically interfere with said second resonator strip to impart a stress on said second resonator strip which shifts said resonant frequency minimum to said bias point.

2. A magnetomechanical marker as recited in claim 1, wherein said unannealed magnetostrictive amorphous metal alloy comprises on an elemental weight basis about 2.8% to about 5% boron, about 0 to about 9.5% molybdenum, about 41% to about 55% nickel, and about 33% to about 48% iron.

3. (canceled)

4. A magnetomechanical marker as recited in claim 1, wherein said bias magnet has a frequency versus bias slope from about 0 to about 250 hertz per oersted to magnetically bias said magnetomechanical element, said bias material imparting a field between about 450 and about 550 ampere-turns per meter on said first and second resonator strips.

5. A magnetomechanical marker as recited in claim 2, wherein said bias magnet has a frequency versus bias slope from about 0 to about 250 hertz per oersted to magnetically bias said magnetomechanical element, said bias material imparting a field between about 450 and about 550 ampere-turns per meter on said first and second resonator strips.

6. (canceled)

7. (canceled)

8. (canceled)

9. (canceled)

10. A magnetomechanical marker as recited in claim 1, wherein said first resonator strip is positioned so that said first resonator strip is in contact with said second resonator strip.

11. (canceled)

12. An electronic article surveillance system comprising: an antenna for generating an electromagnetic field alternating at a selected frequency in an interrogation zone; a magnetomechanical marker comprising: a magnetomechanical element comprising first and second resonator strips composed of an unannealed magnetostrictive amorphous metal alloy having a resonant frequency response including a resonant frequency minimum in response to said electromagnetic field, a bias magnet having a bias point to magnetically bias said magnetomechanical element so that said magnetomechanical element resonates at a predetermined frequency in the presence of said electromagnetic field, and a housing having a cavity sized and shaped to accommodate said first and second resonator strips positioned in said cavity in registration and to allow said first and second resonator strips to mechanically vibrate, wherein said first resonator strip has a first weight and a first shape and is positioned proximate said second resonator strip so that said first weight and said first shape mechanically interfere with said second resonator strip to impart a stress on said second resonator strip which shifts said resonant frequency minimum to said bias point; and an antenna for detecting the mechanical vibration of said magnetomechanical element.

13. An electronic article surveillance system as recited in claim 12, wherein said unannealed magnetostrictive amorphous metal alloy comprises on an elemental weight basis about 2.8% to about 5% boron, about 0 to about 9.5% molybdenum, about 41% to about 55% nickel, and about 33% to about 48% iron.

14. (canceled)

15. An electronic article surveillance system as recited in claim 12, wherein said bias magnet has a frequency versus bias slope from about 0 to about 250 hertz per oersted to magnetically bias said magnetomechanical element, said bias material imparting a field between about 450 and about 550 ampere-turns per meter on said first and second resonator strips.

16. An electronic article surveillance system as recited in claim 13, wherein said bias magnet has a frequency versus bias slope from about 0 to about 250 hertz per oersted to magnetically bias said magnetomechanical element, said bias material imparting a field between about 450 and about 550 ampere-turns per meter on said first and second resonator strips.

17. (canceled)

18. (canceled)

19. An electronic article surveillance system as recited in claim 21, wherein said bias magnet has a frequency versus bias slope from about 0 to about 250 hertz per oersted to magnetically bias said magnetomechanical element, said bias material imparting a field between about 450 and about 550 ampere-turns per meter on said first and second resonator strips.

20. (canceled)

21. An electronic article surveillance system as recited in claim 12, wherein said first resonator strip is positioned so that said first resonator strip is in contact with said second resonator strip.

22. (canceled)
